(19) United States
(12) Patent Application Publication
(10) Pub. No.: US 2016/0127497 A1
(43) Pub. Date: May 5, 2016

(54) SMART SITE PRELOADING

(71) Applicants: Evgeny Himmelreich, Modiin (IL); Ariel Tammam, Hadera (IL)

(72) Inventors: Evgeny Himmelreich, Modiin (IL); Ariel Tammam, Hadera (IL)

(21) Appl. No.: 14/531,180

(22) Filed: Nov. 3, 2014

(51) Int. Cl. H04L 29/08

(52) U.S. Cl. CPC H04L 67/2847; H04L 67/02

(57) ABSTRACT

A method, medium, and system for receiving a request to load a hierarchical content container, the request being invoked in reply to an event and the hierarchical content container referencing at least one page and other content item; retrieving a site structure of the requested hierarchical content container exclusive of a structure of the at least one page and the other content item referenced by the hierarchical content container; and presenting a representation of the site structure of the requested hierarchical content container in a user interface, as well as receiving a request to load an application, the request being invoked in reply to an event and the application referencing a plurality of application resources; and loading the application, in reply to the request and based on a usage ranking assigned to each of the plurality of application resources, a sub-set of the plurality of application resources.

### BACKGROUND

The loading of web sites, including the numerous web pages that may be referenced by a typical web site can be done at the startup of an application, service, or web site. The automatic loading of the web site is often referred to as preloading or prefetching of the web site. Web sites may be preloaded in an effort to provide a client-side device with the resources the client user may want or need access to in conjunction with a navigation of the web site. However, the preloading of a web site may, in a first instance, present an unfavorable impression on the user if the preloading is a time-consuming venture. The preloading of the web site may be time-consuming since, from a resources perspective, the retrieval and loading of web pages may be a heavy consumer of system resources including but not limited to memory, processing capacity, power consumption, and communication channel bandwidth.

### BRIEF DESCRIPTION OF THE DRAWINGS

FIG. 1 is a logical depiction of a system, according to some embodiments;

FIG. 2 is a logical depiction of a hierarchical content containe, in accordance with some embodiments;

FIG. 3 is a flow diagram of a process, in accordance with some embodiments;

FIG. 4 is a flow diagram of a process, in accordance with some embodiments;

FIG. 5 is a flow diagram of a process, in accordance with some embodiments;

FIG. 6 is a flow diagram of a process, in accordance with some embodiments; and

FIG. 7 is a block diagram of a computing device, in accordance with some embodiments.

### DETAILED DESCRIPTION

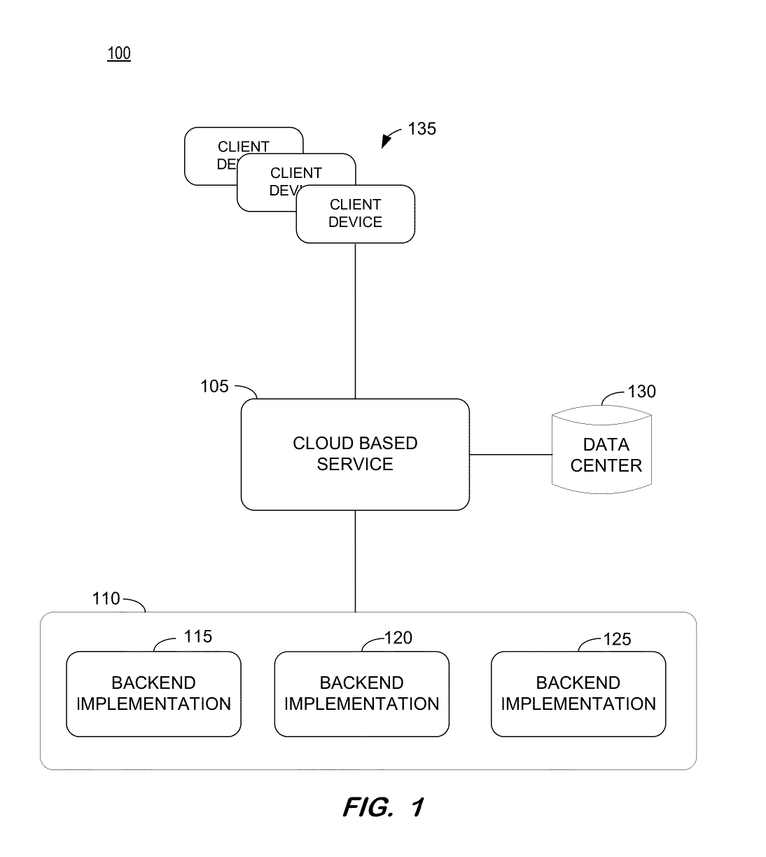

FIG. 1 is a block diagram of a system or platform 100, according to some embodiments herein. System 100 represents a logical architecture for describing processes and a framework to preload, prefetch, or otherwise initiate a loading of a resource to enhance a user experience. In some embodiments, system and framework 100 may facilitate a process that prevents an initialization or loading of a resource. In some aspects, resources that may be preloaded or prevented from preloading may include web resources. As used herein, a web resource may include a document, a file (any type), an application, a service, and other entities that may be identified and addressed by for example, a uniform resource locator (URL), a uniform resource identifier (URI), an internationalized resource identifier, and other identifiers whether standardized or not. Actual implementations of system 100 may include more, fewer, alternative, or different components arranged in similar or other manners than that shown in FIG. 1.

System 100 includes a cloud based service 105. Cloud based service 105 may be provided by a service provider 110. Service 105 may be, without limit or loss of generality, a business service (e.g., a procurement service, a customer support service, etc.), a cloud-based application, a social networking service, a messaging service, an entertainment hub, and other applications and services. In some embodiments, service provider 110 may employ an instance of an in-memory database system in the implementation of backend systems 115, 120, and 125. Backend implementations 115, 120, and 125 may operate alone or in combination to deliver one or more services and applications 105 to client devices 135. In some embodiments, one or more of the backend implementations may include an instance of an in-memory database system, such as SAP HANA. The processes and concepts disclosed herein are not limited to any one system or technical implementation thereof.

In some embodiments, client devices (or simply clients) 135, service provider 110, and a data center 130 supporting the operation and availability of cloud based service 105 may be distributed throughout different locations remote from each other. For example, a client 135 located in China may request cloud based service 105 as provided by a service provider 110 located in the U.K., where data center 130 may be embodied in a data center located in the U.S. In order to deliver the desired service to the client, a number of communication and data calls may typically be made to, for example, backend implementation 125 and data center 130. Data calls from the client located in China and the data center located in the U.S. may experience some lag due to the latency of communication between such far-flung destinations. The latency of such communications may be readily evident to a user of client device 135 when an initialization of the service (e.g., web site, web page, cloud based application and/or service) may operate to load a number of applications, services, and other web resources in advance of the user making any specific requests for the resources.

In some contexts, a preloading or prefetching of resources in response to the initialization of the service 105 may be based on the user's role or responsibility within a business, business organization, online community, and other organizations and institutions. While the automatic preloading or prefetching (used interchangeably herein) of an application, a hierarchical content container, and other resources to or for use by a client may be performed with an intention of loading the applications, hierarchical content container, and other resources that a user entity may ultimately use or want to use during a session with service 105, the actual preloading or prefetching may be perceived by the user entity as a time-consuming, less than instantaneous process. The preloading or prefetching may be perceived as an annoyance since the preloading or prefetching may occur when a user entity logs into cloud based service 105, before they even specify a purpose of their current session with the service. As used herein, a hierarchical content container may refer to and encompass a class and a data structure, instances of which may be collections of other content. Such content may include any type of hierarchically related content including, for example, a web site including or referencing a set of web pages (i.e., pages) and/or content, a document, a book formatted in (plain) text and/or a markup language (e.g., Hypertext Markup Language, HTML or XHTML), an application and/or a reference or pointer to an application, and other addressable resources, still images, videos, audio content, multimedia content, structured data, and other types of hierarchically related content.

In some embodiments, processes, mediums, and systems herein may operate to provide a preloading or prefetching of a resource in a manner that enhances, for example, a user entity's experience. In some aspects, the user entity's experience may be enhanced as perceived at an outward facing user interface (e.g., a graphical user interface that presents an interactive portal to a service, application, or other resource).

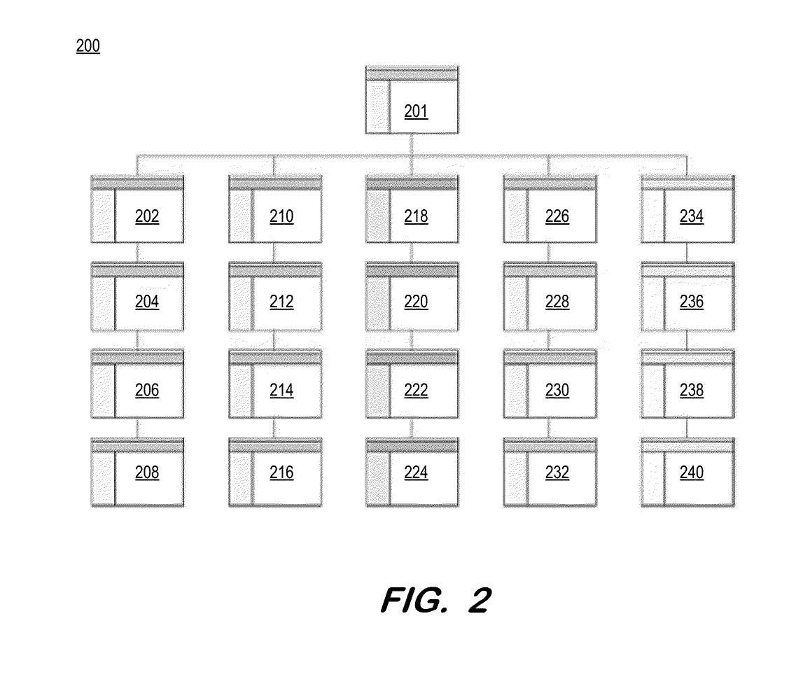

FIG. 2 is an illustrative depiction of a hierarchical content container 200 that may be associated with a cloud based service, in accordance with some embodiments herein. FIG. 2 is a logical representation of a hierarchical content container including a plurality of content items 201-240. In some aspects, the hierarchical content container may be an embodiment of a web site, a document having multiple sections (e.g., sentences, paragraphs, and chapters/sections), an application having a number of different functional “modules, and other entities. Accordingly, the content items 201-240 of FIG. 2 may include or reference a related set of web pages (i.e., pages) and/or other content comprising a web site including a home page (e.g., 201) and related pages (e.g., 202-240), the chapters and other sub-sections (e.g., 202-240) of a document (e.g., 201), an application and/or a reference or pointer to an application (e.g., 201) and the related application modules (e.g., 202-240) providing the different functionalities of the application, and other addressable resources. In some instances, the content may include, but is not limited to, still images, videos, audio content, multimedia content, structured and unstructured data, and other types of hierarchically related content.

In some embodiments, the hierarchical content container may include a web site comprising hundreds or even thousands of pages of content. In some aspects, hierarchical content container 200 may convey the relationships between the pages of content. In some embodiments, hierarchical content container 200 may include a home page 201 and subtopic menu pages 202, 210, 218, 226, and 234. Each of the subtopic pages may have one or more pages associated therewith. For example, page 202 is further associated with pages 204-208, page 210 is also associated with pages 212-216, page 218 is also associated with pages 220-224, page 226 is further associated with pages 228-232, and subtopic page 202 is also associated with pages 236-240.

In some embodiments, the hierarchical content container may include an application comprising multiple components that provide different, related functionalities corresponding to the different application components. For example, the application may be a software suite of office productivity applications and hierarchical content container 200 may convey the relationships between the different application components. In some embodiments, hierarchical content container 200 may include a home user interface component 201 and related functionality application components 202, 210, 218, 226, and 234. Each of the related functionalities may have one or more functions associated therewith. For example, application component 202 (e.g., a word processing application component) is further associated with application components 204-208 (e.g., an equation writer, a spelling checker, a grammar checker, templates, etc.), application component 210 (e.g., a spreadsheet application component) is associated with application components 212-216, application component 218 (e.g., a presentation program component) is associated with application components 220-224, application component 226 (e.g., an email client) is further associated with application components 228-232, and application component 202 (e.g., a diagramming application component) is associated with application components 236-240.

In some embodiments herein, a hierarchical content container includes a set of related data that may be referenced, generated or consumed by a web site, service, and application. In some aspects, hierarchical content container 200 may be a representation of a data file generated or used by an application or service herein. For example, hierarchical content container 200 may be a logical representation of a spreadsheet generated and updated by a business organization. The plurality of nodes representing content items included in the hierarchical content container may represent different pages of the spreadsheet and other sections thereof.

In some embodiments herein, a hierarchical content container may be organized in configurations other than the tree-like organizational structure of FIG. 2. In some instances, the hierarchical content container may include, at least in part, a hub and spoke structure, a linear structure, and other organizational configurations in addition to, in combination with, and instead of the representative configuration depicted in FIG. 2.

In some aspects, the pages of content of hierarchical content container 200 (e.g., a web site) may comprise resources to provide a service or application provided by cloud based service 105. In some embodiments, the resources may include at least one of: a document, a book (text and/or a markup language), a software widget, an application and/or a reference or pointer to an application, and other addressable resources, and multimedia content, structured and unstructured data, and other types of content.

In some aspects, a site structure of hierarchical content container 200 may include the arrangement and relationships between the pages of content of the hierarchical content container. The site structure may be represented by descriptive data, such as metadata, in some embodiments. In some aspects, the site structure may be, at a certain level of abstraction, represented by graphical user interface elements, where the graphical user interface elements may be presented to a user in a format efficiently understood and consumed by the user. In some embodiments, the site structure of hierarchical content container 200 may include graphical representations (e.g., icons) similar to the block diagram representations of FIG. 2.

In some embodiments, while the site structure of hierarchical content container 200 may be descriptive of and convey the configuration and relationships between the content items thereof, the site structure may also be separate and distinct from a structure and data content of the content items comprising the hierarchical content container. That is, the site structure of hierarchical content container 200 may be exclusive of a structure of the one or more content items (web pages, document chapeters, application components, etc.) comprising the hierarchical content container. In some aspects, the site structure of hierarchical content container 200 may effectively convey the relationships between the content items comprising the hierarchical content container without including the details and data of the content items. Accordingly, in some aspects, data file(s) corresponding to the site structure of a hierarchical content container may be smaller than data file(s) corresponding to the entirety of the content items comprising the hierarchical content container.

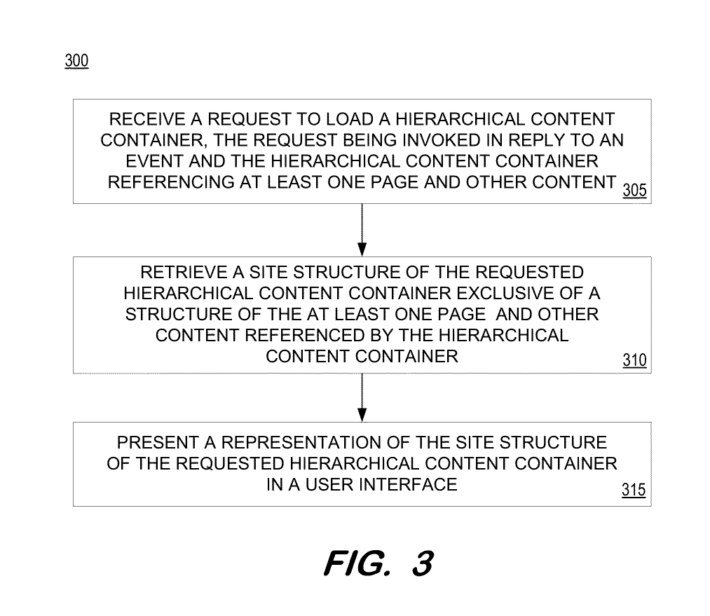

FIG. 3 is an illustrative flow diagram of a process 300, in accordance with some aspects herein. In some embodiments, process 300 may be implemented, at least in part, by a system such as the logical architecture of FIG. 1. Process 300 and other processes herein, may be implemented by a system, application, or apparatus configured to execute the operations of the process(es). In some embodiments, various hardware elements of system 100 execute program instructions to perform process 300. In some embodiments, hard-wired circuitry may be used in place of, or in combination with, program instructions for implementation of processes according to some embodiments. Embodiments are therefore not limited to any specific combination of hardware and software.

Prior to operation 305, a program executing on a client device 135 or a server-side computing device 105 (e.g., an application server) may be developed and deployed to one or more device(s) to implement process 300. That is, process 300 may comprise a portion or part of a larger or different process.

Operation 305 may include receiving a request to load a hierarchical content container. The request of operation 305 may be invoked by an event. The event may be the action of a user entity logging onto a device (e.g., 135, 105), system (e.g., 100), the requested or other hierarchical content container, an application, a service (e.g., 105), and other actions that may be defined to trigger the request. The requested hierarchical content container may reference or include a plurality of web pages and other content items. Loading all of the pages and other content comprising or referenced by the hierarchical content container may take some appreciable, non-trivial amount of time. Actions to reduce or otherwise minimize the time to load the content of the requested hierarchical content container may enhance the user entity's experience in interacting with a service associated with the hierarchical content container.

At operation 310, a site structure of the hierarchical content container is retrieved in response to the reception of the request. In accordance with aspects herein, a structure of the content items (e.g., web pages and other content) associated with the requested hierarchical content container are not however retrieved. That is, the structure of the site, document, application, etc. is retrieved, exclusive of the structure(s) of the corresponding pages, document sections, application components, and other content comprising or referenced by the hierarchical content container being retrieved. In this manner, the quantity and extent of resources retrieved in reply to the hierarchical content container may be reduced and the time to retrieve (i.e., load) the resources is also reduced.

Operation 315 includes an output of the retrieved site structure. In some aspects, the retrieved site structure may be presented in a graphical user interface to the user entity. The user entity may, at their discretion, navigate to a particular content item (e.g., a web page and other content) comprising or referenced by the hierarchical content container by selecting a representation of a desired content item (e.g., web page, etc.) in the site structure of the hierarchical content container presented to them.

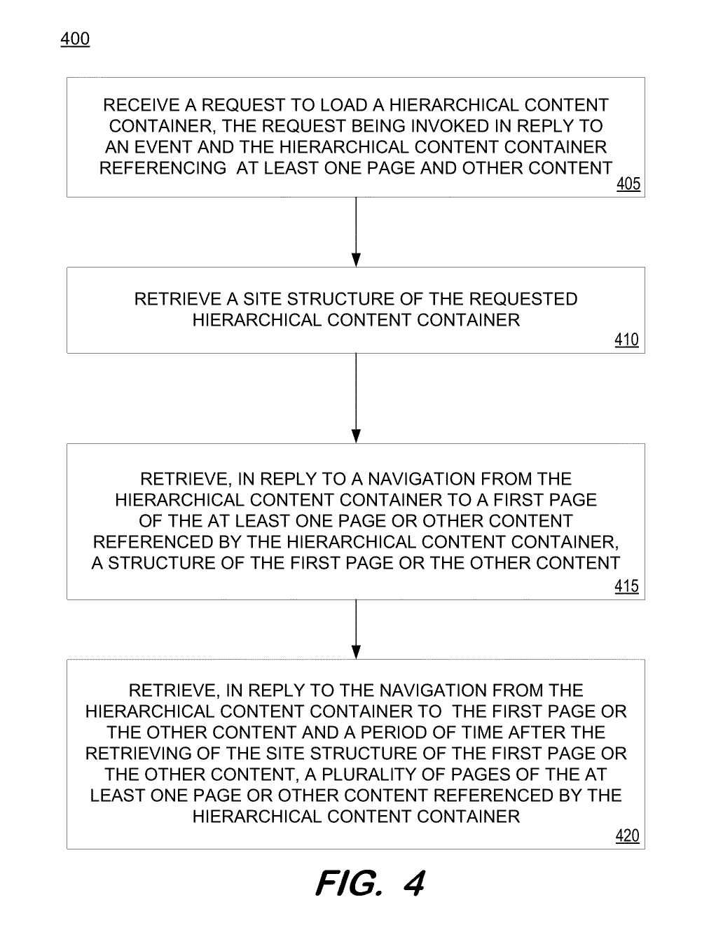

FIG. 4 is an illustrative flow diagram of a process 400, in accordance with some aspects herein. In some embodiments, process 400 may be implemented, at least in part, by a system such as the logical architecture of FIG. 1. At operation 405, a request to load a hierarchical content container is received. The request may be received by a server of a service provider. The request may be automatically invoked in reply to an action. The action may include a user entity logging on or in to a system, service, or device, in a manner similar to that introduced in the discussion of process 200, for example.

At operation 410, a site structure for the requested hierarchical content container may be retrieved. In some instances, the structures of web pages and other content forming or referenced by the hierarchical content container are not retrieved at operation 410. At operation 415, in reply to a navigation from the hierarchical content container to a first (web) page or other content of the hierarchical content container by a user entity, a structure of the first page or other content may be retrieved. In this manner, the structure of a specifically requested web page or other content item is retrieved and loaded when it is requested and not in, for example, an arbitrary manner. In some aspects, the preloading in reply to an initialization event may be improved with respect to process 400.

At operation 420, additional web pages and other content item(s) may be retrieved in reply to the navigation that caused the retrieval of the first page or other content item(s). The retrieval of additional web pages and other content item(s) may be performed to reduce the number of trips to retrieve or call a data store to retrieve related web pages and other content items. In some aspects, the additional web pages and other content items of operation 420 are being preloaded in reply to the loading of the first requested web page and other content item. In some regards, the additional web pages and other content item may be specified to be 2, 3, or another number of “neighboring” web pages and other content (e.g., documents, books, videos, audio files, etc.). The “neighboring” web pages and other content items may be (hierarchically) related or associated with the first web page and other content item in some manner. The manner in which they are related may be defined by a developer and may, in some aspects, be determined based on metadata of the requested first page and other root content item and the additional web pages and other content items. In some regards, the additional web pages and other content items are retrieved after the passage of some time, after the retrieval of the first page and other content item. In this manner, the loading of the requested first page and other content item may not be hindered or encumbered by the loading of the additional web pages and other content items.

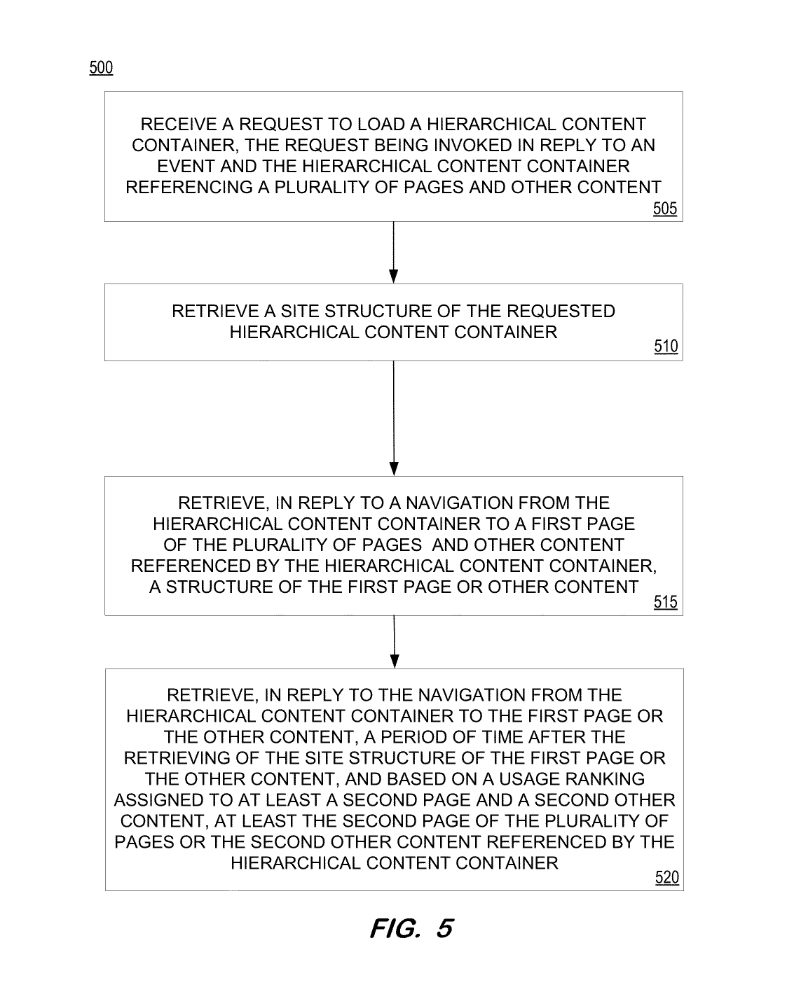

FIG. 5 is an illustrative flow diagram of a process 500, in accordance with some aspects herein. In some embodiments, process 500 may be implemented, at least in part, by a system such as the logical architecture of FIG. 1. At operation 505, a request to load a hierarchical content container is received. The request may be received by a server of a service provider. The request may be automatically invoked in reply to an action. The action may include a user entity logging on or in to a system, service, or device, in a manner similar to that introduced in the discussion of process 300 and 400, for example. The requested hierarchical content container may comprise a plurality of web pages and other content items, where the other content items may be associated with a web site or other type of content, in accordance with other aspects herein.

At operation 510, a site structure for the requested hierarchical content container may be retrieved. In some instances, the structures of web pages and other content item(s) forming the hierarchical content container are not retrieved at operation 510. At operation 515, in reply to a navigation from the hierarchical content container to a first (web) page and other content item comprising the hierarchical content container by a user entity, a structure of the first page and other content item may be retrieved. Thus, the structure of the specifically requested first web page or other content item is retrieved and loaded when it is requested and not in, for example, an arbitrary manner or in reply to some generic event (e.g., system log-in).

At operation 520, additional web pages and other content item(s) may be retrieved in reply to the navigation that caused the retrieval of the first page or other content item, after the passage of a specified or determined period of time. The retrieval of additional web pages and other content item(s) may be performed to reduce the number of trips to retrieve or call a data store to retrieve web pages and other content. In some aspects, the additional web pages and other content item(s) of operation 520 are being preloaded in reply to the loading of the first requested web page or other content item and based on a usage ranking of the plurality of pages and other content item(s) comprising the requested web site. In some regards, each of the pages and other content item(s) comprising the web site or other entity is assigned a relative ranking. The rankings may be assigned and determined for the specific user entity or user entity group to which the user entity belongs (e.g., their role or responsibility within a business organization). In some aspects, the web pages and other content item(s) with the highest usage ranking, or a sub-set thereof, may be retrieved. The usage rankings may be based on, for example, on a user entity's usage of resources, role, geo-location, a predicted usage, and a period of time. In some respects, the usage ranking may be based on these and other factors as determined in relation to an entity other than the user entity making the request. This other entity may be deemed a suitable representative or proxy of the user entity. In this manner, actual usage need not be observed for the user entity making the hierarchical content container request for the usage ranking to be applicable to the user entity and have reliable predicative value.

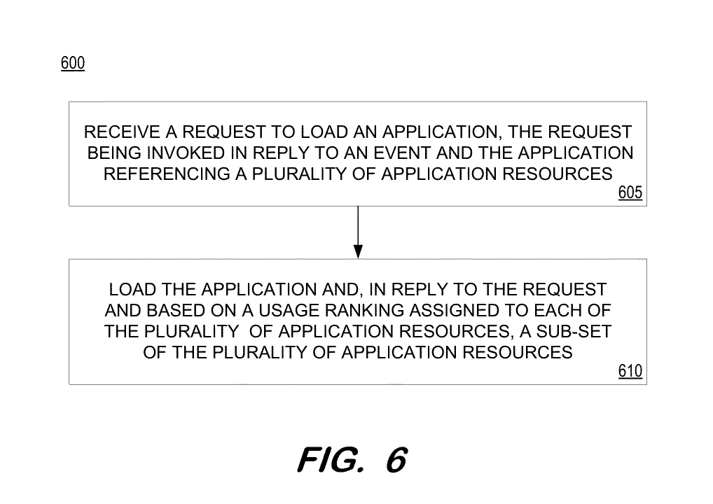

FIG. 6 is an illustrative flow diagram of a process 600, in accordance with some aspects herein. In some embodiments, process 600 may be implemented, at least in part, by a system such as the logical architecture of FIG. 1. In some embodiments, the hierarchical content container may include an application comprising multiple components that provide different, related functionalities corresponding to the different application components. For example, the application may be a software suite of office productivity applications and hierarchical content container 200 may convey the relationships between the different application components. In some embodiments, hierarchical content container 200 may include a customer support service or application providing a platform for an organization to support business applications deployed and serviced by the organization, where the hierarchical content container may convey the relationships between the different customer support functionalities of the platform.

At operation 605, a request to load an application is received. The request may be automatically invoked in reply to an action. The action may include a user entity logging on or in to an application, a system, service, or device. In some aspects, the action may be invoked by other actions such as, for example, a time or other activity. The time aspect may be related to a specific time of day, day of the week, day(s) of a month, month(s), year(s), and other periods thereof. Other example activities and actions that can invoke a request to load an application may include, for example, a period of time following the release and deployment of a new and/or updgraded application component when an increase in customer support calls may be reasonably anticipated and predicted. In the context of the deployment of a new or upgraded application, a request for the preloading of one or more components of the customer support service or application of the present example may be invoked based in a response to the deployment of the new or upgraded application component. In other contexts, a request for some or all of the customer support service or application components may not normally be invoked.

At operation 610, the application indicated in the request may be loaded in a limited or specific manner. In some aspects, an embodiment of process 600 may relate to a request to load either application components or application resources, while some embodiments relate to a request to load both application components and application resources. For example, an application or service may typically operate to load a plurality or all of the constituent application components and associated resources related to the application. However, in the instance of operation 610, each of the application components and resources may have an assigned usage ranking and the application components and resources may be loaded based on the relative ranking of the application components and resources. A higher usage ranking may indicate a higher probability of the user entity actually using the resource, as determined based on observed or predicted behavior for the user entity. In some aspects, the predicated behavior may be based on a variety of considerations, alone or in combination, such as, for example, the deployment of a new or upgraded application. In some instances, the highest ranking application components and resources of the application may be loaded (e.g., a trouble-shooting guide, the two most frequently opened sheets of a spreadsheet comprising ten different sheets for a resource of the application). In some aspects, the preloading of the application components and associated resources in reply to an initialization or other event may be improved with respect to process 600. In some aspects, the loading of other additional application components and associated resources related to the application may be loaded in request to a specific navigation to or request for the additional application components and associated resources, in accordance with one or more of the other processes disclosed herein (e.g., processes 300, 400, and 500).

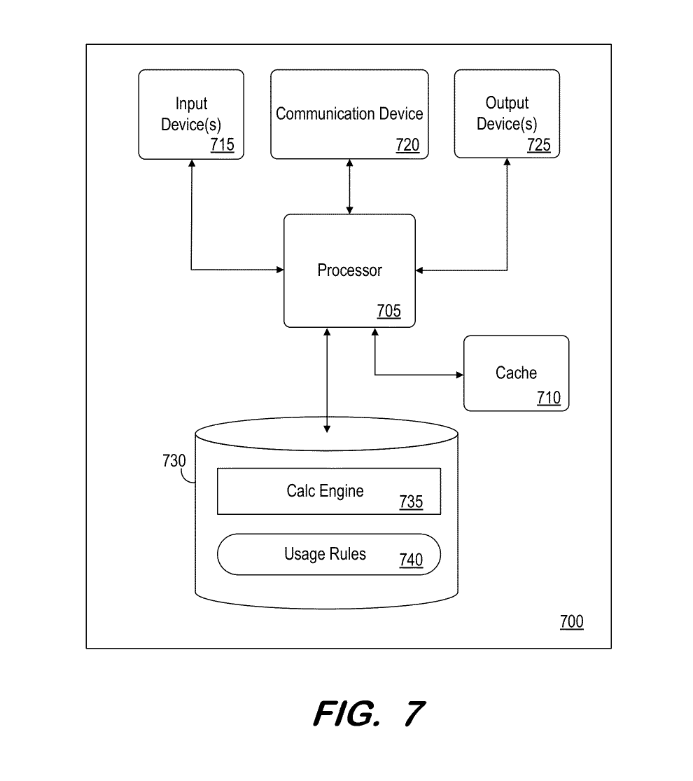

FIG. 7 is a block diagram overview of a system or apparatus 700 according to some embodiments. System 700 may be, for example, associated with any of the devices described herein, including for example a platform of FIG. 1 and aspects thereof. System 700 comprises a processor 705, such as one or more commercially available Central Processing Units (CPUs) in the form of one-chip microprocessors or a multi-core processor, coupled to a communication device 720 configured to communicate via a communication network (not shown in FIG. 7) to another device or system. In the instance system 700 comprises a device or system (e.g., supporting a real-time semantic rule-based temporal reasoning platform), communication device 720 may provide a mechanism for system 700 to interface with a monitored entity (e.g., an application, device, system, or service). System 700 may also include a cache 710, such as RAM memory modules. The system further includes an input device 715 (e.g., a touchscreen, mouse and/or keyboard to enter content) and an output device 725 (e.g., a touchscreen, a computer monitor to display, a LCD display).

Processor 705 communicates with a storage device 730. Storage device 730 may comprise any appropriate information storage device, including combinations of magnetic storage devices (e.g., a hard disk drive), optical storage devices, solid state drives, and/or semiconductor memory devices. In some embodiments, storage device 730 may comprise a database system, including in some configurations an in-memory database.

Storage device 730 may store a calculation engine that may provide computer executable instructions for implementing processes herein, including for example a determine of a usage ranking. Processor 705 may perform the instructions of the program instructions 735 to thereby operate in accordance with any of the embodiments described herein. Program instructions 735 may be stored in a compressed, uncompiled and/or encrypted format. Program instructions 735 may furthermore include other program elements, such as an operating system, a database management system, and/or device drivers used by the processor 705 to interface with, for example, peripheral devices (not shown in FIG. 7). Storage device 730 may also include data 740 such as usage rules and the criteria for evaluating the usage rules in determining a usage ranking as disclosed in some embodiments herein. Data 740 may be used by system 700, in some aspects, in performing one or more of the processes herein, including individual processes, individual operations of those processes, and combinations of the individual processes and the individual process operations.

All systems and processes discussed herein may be embodied in program code stored on one or more computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

In some embodiments, aspects herein may be implemented by an application, device, or system to manage recovery of an entity or other application in a consistent manner across different devices, effectively across an entire domain.

Although embodiments have been described with respect to cloud-based entities, note that embodiments may be associated with other types of entities that need not be cloud-based, either in part or whole without any loss of generality.

The embodiments described herein are solely for the purpose of illustration. Those in the art will recognize other embodiments which may be practiced with modifications and alterations.

What is claimed is:

1. A method implemented by a computing system in response to execution of program instructions by a processor of the computing system, the method comprising:
receiving a request to load a hierarchical content container, the request being invoked in reply to an event and the hierarchical content container site referencing at least one page and other content item;
retrieving a site structure of the requested hierarchical content container exclusive of a structure of the at least one page and the other content item referenced by the hierarchical content container; and
presenting a representation of the site structure of the requested hierarchical content container in a user interface.

2. The method of claim 1, further comprising retrieving, in reply to a navigation from the hierarchical content container to a first page or other content item of the at least one page and other content referenced by the hierarchical content container, a structure of the first page and other content item.

3. The method of claim 1, wherein the event invoking the request is at least one of a user logging onto a device, a system, the hierarchical content container, an application, and a service.

4. The method of claim 1, wherein the request further comprises a request to load an application.

5. A method implemented by a computing system in response to execution of program instructions by a processor of the computing system, the method comprising:
receiving a request to load a hierarchical content container, the request being invoked in reply to an event and the hierarchical content container referencing at least one page and other content item;
retrieving a site structure of the requested hierarchical content container;
retrieving, in reply to a navigation from the hierarchical content container to a first page or other content item of the at least one page and the other content item referenced by the hierarchical content container, a structure of the first page or the other content item; and
retrieving, in reply to the navigation from the hierarchical content container to the first page and a period of time after the retrieving of the site structure of the first page, a plurality of pages or the other content items of the at least one page or other content item referenced by the hierarchical content container.

6. The method of claim 5, wherein the retrieving of the site structure of the requested hierarchical content container includes excluding the retrieval of a structure of the at least one page and the other content item referenced by the hierarchical content container.

7. The method of claim 5, wherein the retrieving of the plurality of pages or the other content items of the at least one page and the other content item referenced by the hierarchical content container includes retrieving a structure of each of the plurality of pages and the other content items.

8. The method of claim 5, wherein the event invoking the request is at least one of a user logging onto a device, a system, the hierarchical content container, an application, and a service.

9. The method of claim 5, wherein the request further comprises a request to load an application.

10. A method implemented by a computing system in response to execution of program instructions by a processor of the computing system, the method comprising:
receiving a request to load a hierarchical content container, the request being invoked in reply to an event and the hierarchical content container referencing a plurality of pages and other content items;
retrieving a site structure of the requested hierarchical content container;
retrieving, in reply to a navigation from the hierarchical content container to a first page of the plurality of pages and the other content items referenced by the hierarchical content container, a structure of the first page and the other content items; and
retrieving, in reply to the navigation from the hierarchical content container to the first page or the other content items, a period of time after the retrieving of the site structure of the first page and other content items, and based on a usage ranking assigned to at least a second page, the at least second page and second other content items of the plurality of pages and the other content items referenced by the hierarchical content container.

11. The method of claim 10, wherein the retrieving of the site structure of the requested hierarchical content container includes excluding the retrieval of a structure of the at least one page and the other content items referenced by the hierarchical content container.

12. The method of claim 10, wherein the retrieving of the at least second page site and the second other items content includes retrieving a structure of each of the at least second page and the second other content items.

13. The method of claim 10, wherein the event invoking the request is at least one of a user logging onto a device, a system, the hierarchical content container, an application, and a service.

14. The method of claim 10, wherein the request further comprises a request to load an application.

15. The method of claim 10, wherein the usage ranking assigned to the at least second page and the second other content items is based on at least one of usage analytics, a predicted usage, a role, and a geo-location of at least one of a user entity initiating the request and a user entity other than the user entity initiating the request; and a period of time.

16. A method implemented by a computing system in response to execution of program instructions by a processor of the computing system, the method comprising:
receiving a request to load an application, the request being invoked in reply to an event and the application referencing a plurality of application resources; and
loading the application and, in reply to the request and based on a usage ranking assigned to each of the plurality of application resources, a sub-set of the plurality of application resources.

17. The method of claim 16, wherein the event invoking the request is at least one of a user logging onto a device, a system, the hierarchical content container, an application, and a service.

18. The method of claim 16, wherein the usage ranking assigned to the application resources is based on at least one of usage analytics, a predicted usage, a role, and a geo-location of at least one of a user entity initiating the request and a user entity other than the user entity initiating the request; and a period of time.

19. The method of claim 16, wherein a usage ranking is assigned to the application.

20. The method of claim 19, wherein the usage ranking assigned to the application is based on at least one of usage analytics, a predicted usage, a role, and a geo-location of at least one of a user entity initiating the request and a user entity other than the user entity initiating the request; and a period of time.
